(19) United States
(12) Patent Application Publication
(10) Pub. No.: US 2011/0032154 A1
(43) Pub. Date: Feb. 10, 2011

(54) BROADBAND CIRCULARLY POLARIZED PATCH ANTENNA

(76) Inventors: Hang Leong James Chung, Singapore (SG); Zhining Chen, Singapore (SG); Xianming Qing, Singapore (SG)

Correspondence Address: AXIS INTELLECTUAL CAPITAL PTE LTD., 21 Science Park Road, #03-01 The Aquarius Science Park II, SINGAPORE, 117628, SG

(21) Appl. No.: 12/735,514

(22) PCT Filed: Jan. 22, 2009
(86) PCT No.: PCT/SG2009/000029

§ 371 Date: Oct. 7, 2010

Related U.S. Application Data
(60) Provisional application No. 61/022,541, filed on Jan. 22, 2008.

(51) Int. Cl. H01Q 21/24; H01Q 5/00

(52) U.S. Cl. 343/700 MS

(57) ABSTRACT

An antenna structure for providing a broadband circularly polarized radiation. The antenna structure comprises a feed line layer having an input portion and a first radiating patch layer stacked adjacent to the feed line layer. The feed line layer is shaped and dimensioned as an open loop having an input portion and signals are feedable to the feed line layer via the input portion. The first radiating patch layer has a reference origin defined thereon. The antenna structure also comprises a plurality of probes disposed between the feed line layer and the first radiating patch layer for coupling therebetween. The signals are feedable to the first radiating patch layer via the plurality of probes and each of the plurality of probes are positioned about the reference origin of the radiating patch layer along the length of the feed line layer. The signals achieve a phase difference for providing circularly polarized radiation in response to being fed via the plurality of probes being positioned about the reference origin of the radiating patch layer along the length of the feed line layer.

### FIELD OF INVENTION

The present invention generally relates to broadband antennas. More particularly, the invention relates to broadband circularly polarized antennas.

### BACKGROUND

An antenna is a transducer that converts radio frequency (RF) electric current to electromagnetic waves. The electromagnetic waves are then propagated into space. Most wireless communication systems use either a linearly polarized antenna or a circularly polarized antenna. Circularly polarized antennas radiate circularly polarized wave. The electromagnetic waves are propagated such that the electric field vector of the electromagnetic waves spirals along the direction of wave propagation.

Circularly polarized antennas have conventionally been utilized in various wireless communication systems to enhance system capability or eliminate multi-path reflection interference. For example, in radio frequency identification (RFID) systems operating at ultra high frequency (UHF) and microwave frequency bands, circularly polarized antennas are used as reader antennas to detect RFID tags that are, for example, arbitrarily oriented.

Circularly polarized antennas can be realized when two orthogonal modes, with a ninety degree)(90° phase difference, having equal amplitude are excited. In general, circularly polarized antennas can be categorized into single feed structures or hybrid feed structures.

Circularly polarized antennas having single feed structures are simple in structure design, easy to manufacture, and compact in size. Whereas circularly polarized antennas having hybrid feed structures are complicated in structure design, expensive to manufacture, and not as compact as single feed structures. However, circularly polarized antennas having single feed structures have inherently narrow axial ratio (AR) and have impedance bandwidths ranging from one to two percent (1-2%). In contrast, circularly polarized antennas having hybrid feed structures have a wide AR bandwidth.

Hence it is desirable to provide circularly polarized antennas that are compact and are simple in structure design, yet having wide AR bandwidth.

### SUMMARY

In accordance with one aspect of the invention, an antenna structure is provided. The antenna structure comprises a feed line layer having an input portion and a first radiating patch layer stacked adjacent to the feed line layer. The feed line layer is shaped and dimensioned as an open loop having an input portion and signals are feedable to the feed line layer via the input portion. The first radiating patch layer has a reference origin defined thereon. The antenna structure also comprises a plurality of probes disposed between the feed line layer and the first radiating patch layer for coupling therebetween. The signals are feedable to the first radiating patch layer via the plurality of probes and each of the plurality of probes are positioned about the reference origin of the radiating patch layer along the length of the feed line layer. The signals achieve a phase difference for providing circularly polarized radiation in response to being fed via the plurality of probes being positioned about the reference origin of the radiating patch layer along the length of the feed line layer.

In accordance with another aspect of the invention, an antenna structure is provided. The antenna structure comprises a connector, a ground plane layer and a feed line layer is shaped as an open loop having an input portion. The connector is connectable to the input portion with the ground plane layer disposed therebetween and the feed line layer is separable from the ground plane layer by a first substrate. Signals are feedable to the feed line layer via the input portion. The antenna structure also comprises a first radiating patch layer adjacent to the feed line layer and a plurality of probes disposed between the feed line layer and the first radiating patch layer. The first radiating patch layer has a reference origin defined thereon and the first radiating patch layer is separable from the feed line layer by a second substrate. The plurality of probes couples the feed line layer and the first radiating patch layer, and the signals are feedable from the feed line layer to the first radiating patch layer via the plurality of probes. Each of the plurality of probes is positionable about the reference origin of the first radiating patch layer along the length of the feed line layer. The antenna structure further comprises a second radiating patch layer stacked adjacent to the first radiating patch layer for improvement of axial ratio bandwidth. The first and second radiating patch layers are separable by a third substrate. The signals achieve a substantially ninety degree phase difference for providing circularly polarized radiation in response to being fed via the plurality of probes being positioned about the reference origin of the radiating patch layer along the length of the feed line layer. Operating frequency of the antenna structure is determinable by thickness of each of the first substrate, second substrate and third substrate.

### BRIEF DESCRIPTION OF THE DRAWINGS

The invention is described hereinafter with reference to the following drawings, in which:

FIG. 1a shows an isometric view of an antenna structure comprising a plurality of conductors layers, a Radio Frequency (RF) connector and a plurality of probes, in accordance with an exemplary embodiment of the invention;

FIG. 1b shows a top view of the antenna structure of FIG. 1a;

FIG. 1c shows a sectional elevation of the antenna structure 100 according to view A-A′ of FIG. 1b;

FIG. 2a-c show exemplary dimensions the radiating patch layers and the feed line layer of the antenna structure of FIG. 1a-c;

FIG. 3a shows a graphical representation of the return loss, corresponding to frequency, of the antenna structure of FIG. 1a-c;

FIG. 3b shows a graphical representation of the gain and axial ratio, corresponding to frequency, of the antenna structure of FIG. 1a-c;

FIG. 4a-f show graphical representations of radiation patterns at typical UHF RFID frequencies in x-z plane and y-z plane;

FIG. 5a-d show examples of other primitive geometric shapes which are implementable for the first and second radiating patch layer of the antenna structure of FIG. 1a-c;

FIG. 6a-c show examples of other shapes which are implementable for the feed line layer of the antenna structure of FIG. 1a-c; and

FIG. 7a-b show examples in variations of the width of the feed line layer of the antenna structure of FIG. 1a-c.

### DETAILED DESCRIPTION

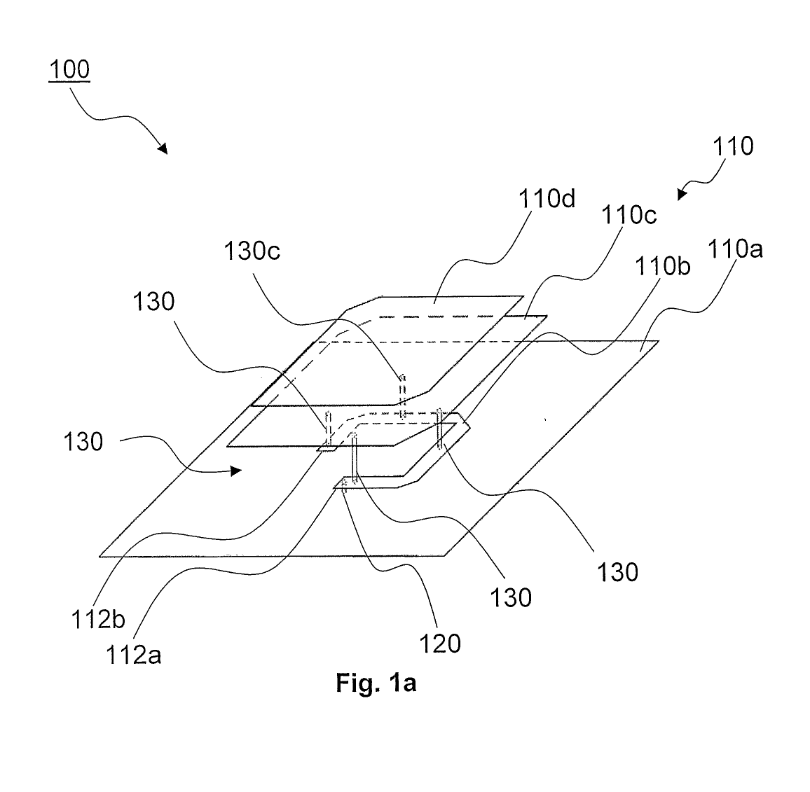

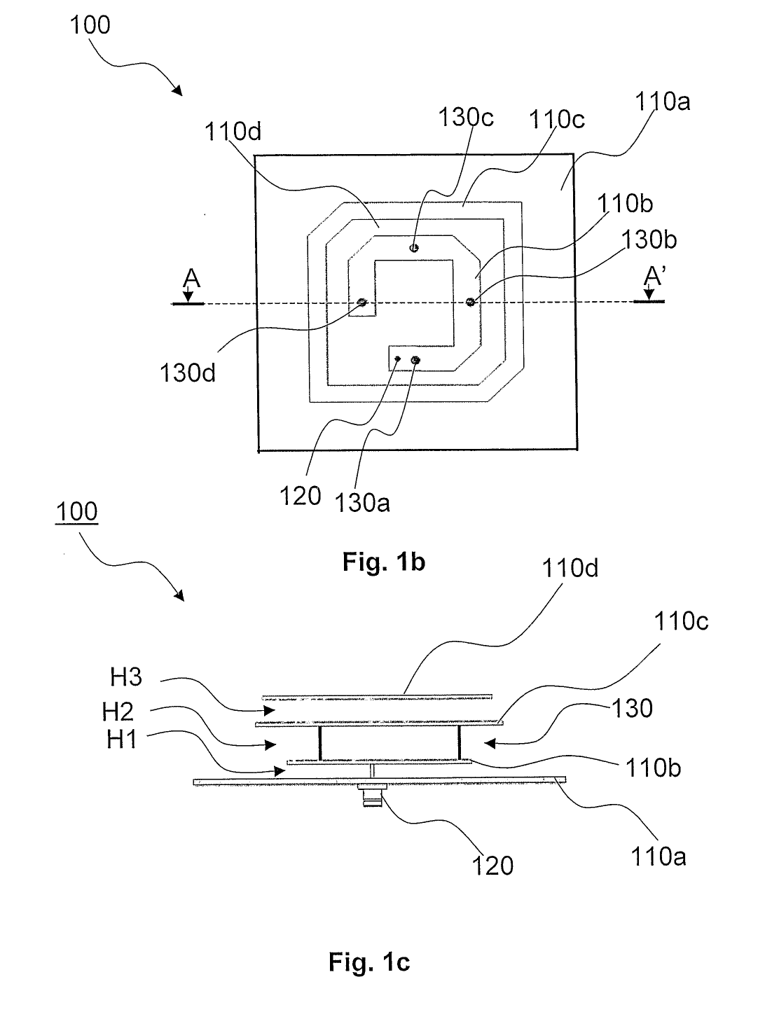

An exemplary embodiment of the invention, an antenna structure 100 for providing a broadband circularly polarized antenna for addressing the foregoing problems of conventional broadband antenna implementations, is described hereinafter with reference to FIG. 1-FIG. 7. The antenna structure 100 is used in wireless communication applications such as RFID applications.

For purposes of brevity and clarity, the description of the present invention is limited hereinafter to the antenna structure 100 for providing a broadband circularly polarized antenna. This however does not preclude various embodiments of the invention from other applications where fundamental principles prevalent among the various embodiments of the invention such as operational, functional or performance characteristics are required.

The antenna structure 100, as shown in FIG. 1a, FIG. 1b and FIG. 1c comprises a plurality of conductor layers 110. FIG. 1a and FIG. 1b provide an isometric view and a top view, respectively, of the antenna structure 100. FIG. 1c shows a sectional elevation of the antenna structure 100 according to view A-A′ of FIG. 1b.

Preferably, the plurality of conductor layers 110 comprise a first conductor layer, a second conductor layer, a third conductor layer and a fourth conductor layer. The first conductor layer is a ground plane layer 110a, the second conductor layer is a feed line layer 110b, the third conductor layer is a first radiating patch layer 110c and the fourth conductor layer is a second radiating patch layer 110d. The feed line layer 110b comprises an input portion 112a and an end portion 112b. Preferably, the plurality of conductor layers 110 are formed by conductive materials such as copper, brass or conductive ink. Alternatively, the plurality conductive layers 110 are formed by patterned conductive traces on a printed circuit board (PCB).

Each of the plurality of conductor layers is separated from another by a substrate. Particularly, the first to fourth conductor layers are separated from each other by a first substrate H1, a second substrate H2 and a third substrate H3.

The antenna structure 100 further comprises a Radio Frequency (RF) connector 120 and a plurality of probes 130. More specifically, the antenna structure 100 comprises a first probe 130a, a second probe 130b, a third probe 130c and a fourth probe 130d.

As shown in FIG. 1a and FIG. 1c, the first radiating patch layer 110c is disposed adjacent to the second radiating patch layer 110d and the ground plane layer 110a is disposed adjacent to the first radiating patch layer 110c. The feed line layer 110b, which is preferably shaped as an open loop transmission line, is disposed between the ground plane layer 110a and the first radiating patch layer 110c. The RF connector 120 feeds to the feed line layer 110b via the ground plane. The first to fourth probes 130a/130b/130c/130d are disposed between the first radiating patch layer 110c and the feed line layer 110b.

The first and second radiating patch layers 110c/110d are arranged such that the second radiating patch layer 110d is a stacked patch adjacent to the first radiating patch layer 110c. The above arrangement of the first and second radiating patch layers 110c/110d improves the axial ratio bandwidth. The axial ratio bandwidth is further improvable by arranging a plurality of stack patches (not shown) adjacent to the first radiating patch layer 110c.

The first to fourth probes 130a/130b/130c/130d connect the first radiating patch layer 110c and the feed line layer 110b. As apparent in FIG. 1a, the first to fourth probes 130a/130b/130c/130d are positioned at four distinct locations on the feed line layer 110b. The positioning of the first to fourth probes 130a/130b/130c/130d is critical to the functionality and performance of the antenna structure 100.

Particularly, the first to fourth probes 130a/130b/130c/130d probes are positioned such that signals (not shown) can be fed to the first radiating patch layer 110c by the feed line layer 110b, through the first to fourth probes 130a/130b/130c/130d, so as to achieve a radiation that is circularly polarized.

More specifically, the first to fourth probes 130a/130b/130c/130d are disposed along the length of the feed line layer 110b at substantially regularly spaced intervals whereby signals fed to the feed line layer 110b through the RF connector 120 are subsequently fed to the first radiating patch layer 110c with a ninety degree phase difference.

By feeding signals to the first radiating patch layer 110c in a sequential rotating manner above, the signals fed to the feed line layer 110b through one of the first to fourth probes 130a/130b/130c/130d have a ninety degree phase delay relative to signals fed to the feed line layer 110b through another one of the first to fourth probes 130a/130b/130c/130d.

For example, the signals fed through the second probe 130b have a ninety degree phase delay relative to the signals fed through the first probe 130a, the signals fed through the third probe 130c have a ninety degree phase delay relative to the signals fed through the second probe 130b and the signals fed through the fourth probe 130d have a ninety degree phase delay relative to the signals fed through the third probe 130c.

The input portion 112a of the feed line layer 110b is connected, via the ground plane layer 110a, to the RF connector 120 and the end portion 112b of the feed line layer 110b is preferably not terminated. When the end portion 112b of the feed line layer 110b is not terminated, additional loads are not required at the end portion 112b of the feed line layer 110b to terminate the feed line layer 110b. Hence, the end portion 112b of the feed line layer 110b is said to be left ‘open’.

Alternatively, the end portion 112b of the feed line layer 110b is terminated by a terminating load (not shown). Examples of the terminating load are capacitive, inductive or restive loads. The and portion 112b of the feed line layer 110b can also be terminated by short-circuiting the and portion 112b.

As shown in FIG. 1c, the ground plane layer 110a and the feed line layer 110b, the feed line layer 110b and the first radiating patch layer 110c, and the first and second radiating patch layers 110c/110d are separated by the first, second and third substrate H1, H2 and H3 respectively. The operating frequency band of the antenna structure 100 is preferably determined by the thickness of each of the first to third substrate, H1 to H3. Alternatively, the operating frequency band of the antenna structure 100 is determined by either the size of the first and second radiating patch layers 110c/110d or dielectric parameters of each of the first to third substrate, H1 to H3.

Each of the first to third substrate H1/H2/H3 is formed by insulating mediums such as plastic, non-metallic spacers, wood, foam or air. Preferably air is used as the insulating medium. As can be readily appreciated, high gain and broad impedance bandwidth are attainable when air is used as the insulating medium. Furthermore, implementation cost is also reduced.

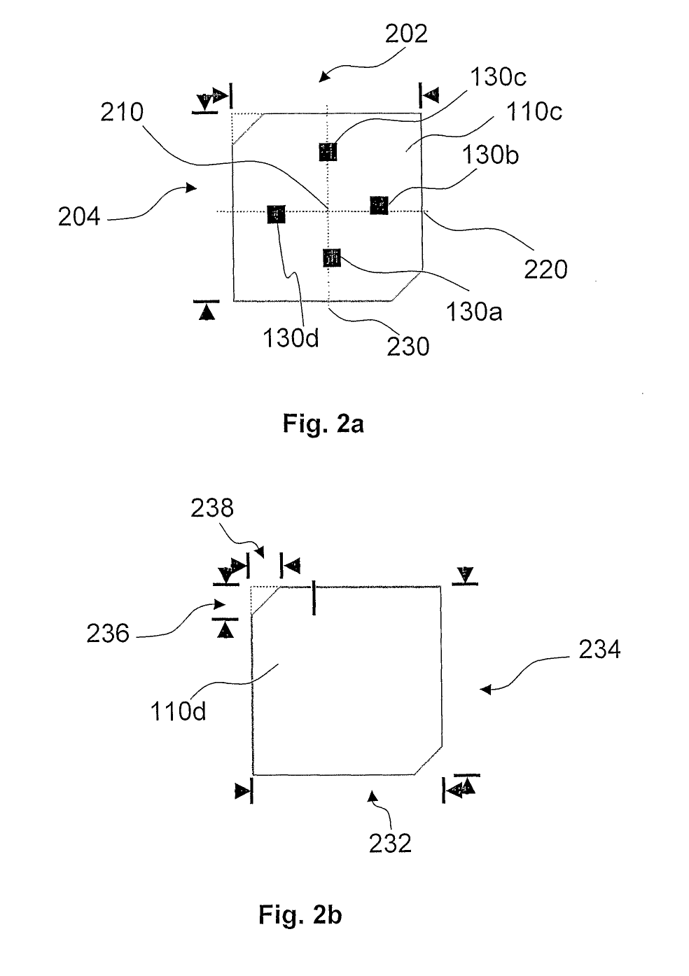

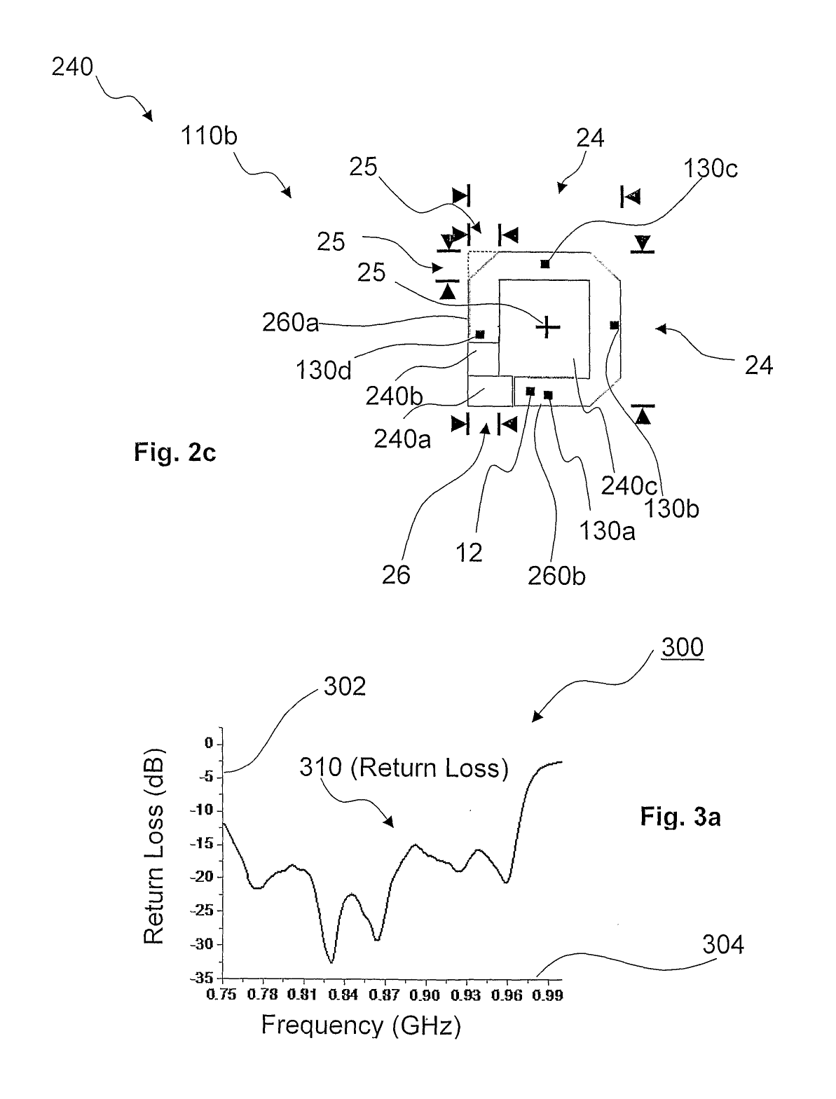

Exemplary dimensions for the first radiating patch layer 110c, the second radiating patch layer 110d and the feed line layer 110b are shown in FIG. 2a, FIG. 2b and FIG. 2c respectively.

The first radiating patch layer 110c is preferably a substantially primitive geometric shape such as a square or a rectangle. The first radiating patch layer 110c has either a length dimension 202 or a breadth dimension 204 of 156 mm. Two adjacent corners of the first radiating patch layer 110c are removed. Each of the removed corners has a base dimension 206 and an altitude dimension 208. For example, either the base dimension 206 or the altitude dimension 208 for the corners removed from the first radiating patch layer 110c is 24.5 mm.

The first to fourth probes 130a/130b/130c/130d are located at coordinates about an origin 210 defined by the cross intercept of an imaginary x-axis 220 and an imaginary y-axis 230 of the first radiating patch layer 110c. Preferably, x-y coordinates of the first to fourth probes 130a/130b/130c/130d are defined in millimeters (mm). Specifically, each of the first to fourth probes 130a/130b/130c/130d has an x-y coordinate of (3.5, −54.5), (57, 1.0), (0.0, 57.5) and (−55, −8) respectively.

Similarly, the second radiating patch layer 110d is preferably a substantially primitive geometric shape such as a square or a rectangle having two adjacent corners removed. The second radiating patch layer 110d has either a length dimension 232 or a breadth dimension 234 of 139 mm. Preferably, the corners removed from each of the first and second radiating patch layers 110c/110d are triangular in shape. Each of the removed corners has a base dimension 236 and an altitude dimension 238. For example, either the base dimension 236 or the altitude dimension 238 for the corners removed from the second radiating patch layer 110d is 17 mm.

The feed line layer 110b is formed from a square shaped plane 240 having four corners and, either a length dimension 242 or a breadth dimension 244 of 121 mm. Portions of the square shaped plane 240 are removed to form the feed line layer 110b.

As shown, a first portion 240a, about an origin 250 defined at the center of the square shaped plane 240, is cutoff. A second portion 240b and a third portion 240c are cutoff from one of the four corners of the square shaped plane 240. Preferably, each of the first, second and third portions 240a/240b/240c is a primitive geometric shape such as a square or a rectangle.

Additionally, the remaining three corners of the square shaped plane are removed. Each of the remaining three corners removed are triangular in shape and has a base dimension 252 and an altitude dimension 254. For example, either the base dimension 252 or the altitude dimension 254 of the remaining three removed corners is 24 mm.

Removal of the first and second portions 240a/240b on one side 260a of the square shaped plane 240 reduces the length dimension of the side 260a from 121 mm to 73.3 mm. Removal of the first portion 240a from another side 260b of the square shaped plane 240 reduces the breadth dimension of the side 260b from 121 mm to 82.6 mm. The feed line layer 110b has a substantially uniform width 262 of 24 mm.

The ground plane layer 110a is preferably a substantially primitive geometric shape such as a square having a length dimension (not shown) and a breadth dimension (not shown) of 250 mm. Furthermore, the thickness of the first to third dielectric, H1 to H3, is of 5 mm, 19 mm and 10 mm respectively. The distance between the second radiating patch layer 110d and the ground plane layer 110a is 35.5 mm.

The antenna structure 100 having the exemplary dimensions provided in FIG. 2a to FIG. 2c is capable of operating at a frequency range of 815 MHz to 970 MHz with a gain of more than 8 dBic and an axial ratio of less than 3 dB. Additionally, return loss of the antenna structure 100 is less than −15 dB. Therefore the operating frequency range of the antenna structure 100 covers the entire ultra high frequency (UHF) RFID frequency band which is typically 840 MHz to 960 MHz.

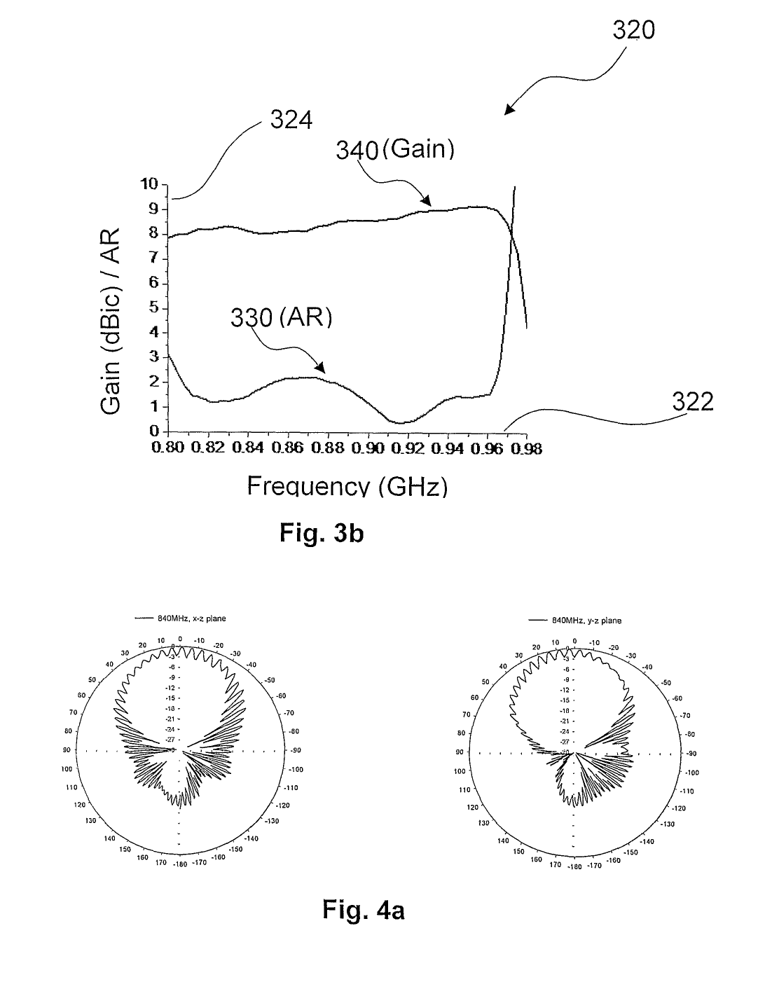

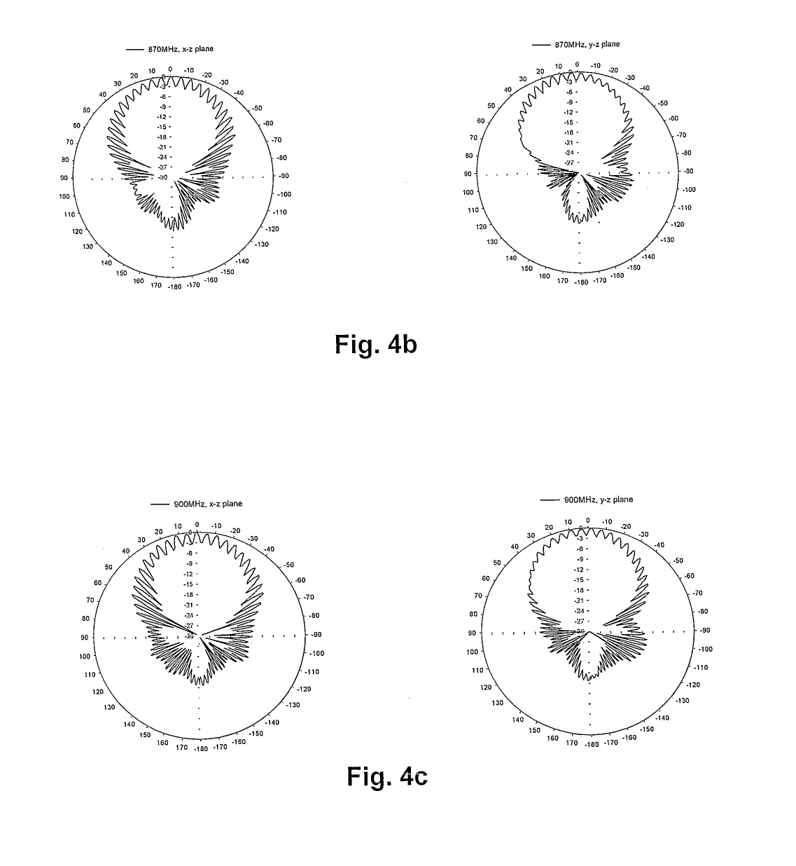

A graphical representation of the return loss of the antenna structure 100 is illustrated by a graph 300 as shown in FIG. 3a. The graph 300 comprises a y-axis 302 quantifying the return loss in dB and an x-axis 304 quantifying the frequency in GHz. The graph 300 also comprises a plot 310 which characterizes the return loss corresponding to the frequency. As can be observed, the return loss at the operating frequency range of 815 MHz to 970 MHz is less than −15 dB.

A graphical representation of the gain and axial ratio of the antenna structure 100 is illustrated by a graph 320. The graph 320 comprises an x-axis 322 quantifying the frequency in GHz and a y-axis 324 quantifying the gain in dBic and the axial ratio in dB. The graph 320 also comprises a first plot 330 and a second plot 340.

The first and second plots 330/340 characterize the axial ratio and gain, respectively, corresponding to the frequency. As can be observed from the first plot 330, the axial ratio at the operating frequency range of 815 MHz to 970 MHz is less than 3 dB. Furthermore, as observed from the second plot 340, the gain at the operating frequency range of 815 MHz to 970 MHz is more than 8 dBic.

As can be readily appreciated, the antenna structure 100 is capable of operating with desirable performance over the entire UHF RFID frequency band without need for complex antenna structure design or configuration. In addition, the antenna structure 100 is robust and is easy to manufacture.

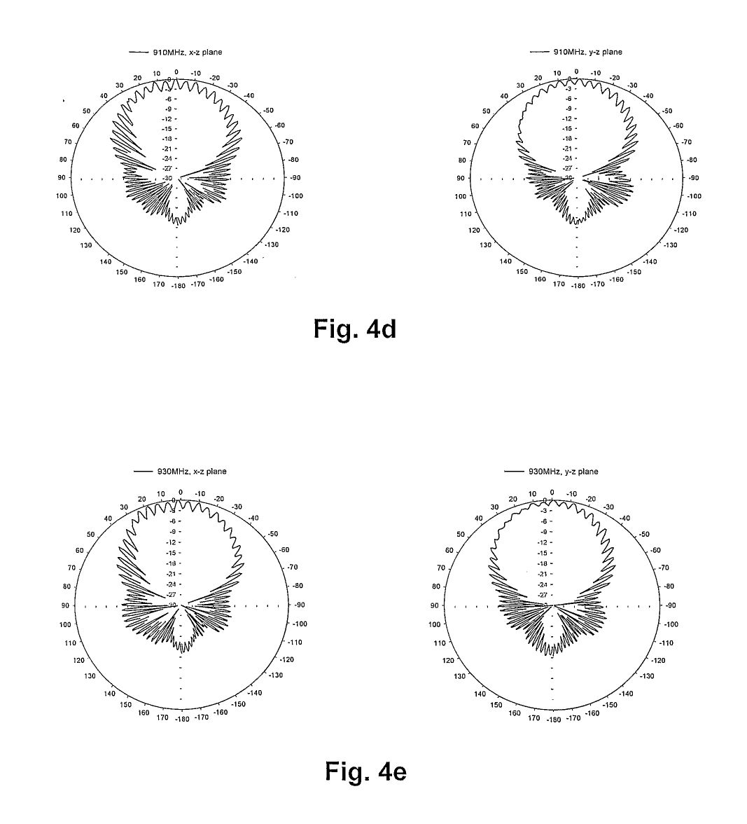

Graphical representations illustrating radiation patterns at typical UHF RFID frequencies in x-z plane and y-z plane are shown in FIGS. 4a to 4f. Radiation patterns at sample frequencies within the UHF RFID frequency range are provided. Specifically, the sample frequencies are 840 MHz, 870 MHz, 900 MHz, 910 MHz, 930 MHz and 950 MHz. The 3-dB axial ratio beamwidths of the radiation patterns at the sample frequencies are tabulated in table 1 below.

TABLE 1
Beamwidth of the 3-dB axial ratio

| | 840 MHz | 870 MHz | 900 MHz | 910 MHz | 930 MHz | 950 MHz |
|---|---|---|---|---|---|---|
| x-z | 85° | 70° | 70° | 80° | 85° | 105° |
| plane | (−35°, 50°) | (−35°, 35°) | (−35°, 35°) | (−45, 35°) | (−50, 35°) | (60°, 45°) |
| y-z | 130° | 115° | 95° | 100° | 113° | 89° |
| plane | (−45°, 75°) | (−45°, 70°) | (−35°, 60°) | (−45°, 55°) | (−38°, 75°) | (−52°, 37°) |

In the foregoing manner, an antenna structure 100 is described for addressing at least one of the foregoing disadvantages. The invention is not to be limited to specific forms or arrangements of parts so described and it will be apparent to one skilled in the art in view of this disclosure that numerous changes and/or modification can be made without departing from the scope and spirit of the invention.

For example, the plurality of conductor layers 110 of the antenna structure 100 described above preferably comprises the first conductor layer, the second conductor layer, the third conductor layer and the fourth conductor layer. Alternatively, the plurality of conductor layers 110 comprises the first conductor layer, the second conductor layer and the third conductor layer.

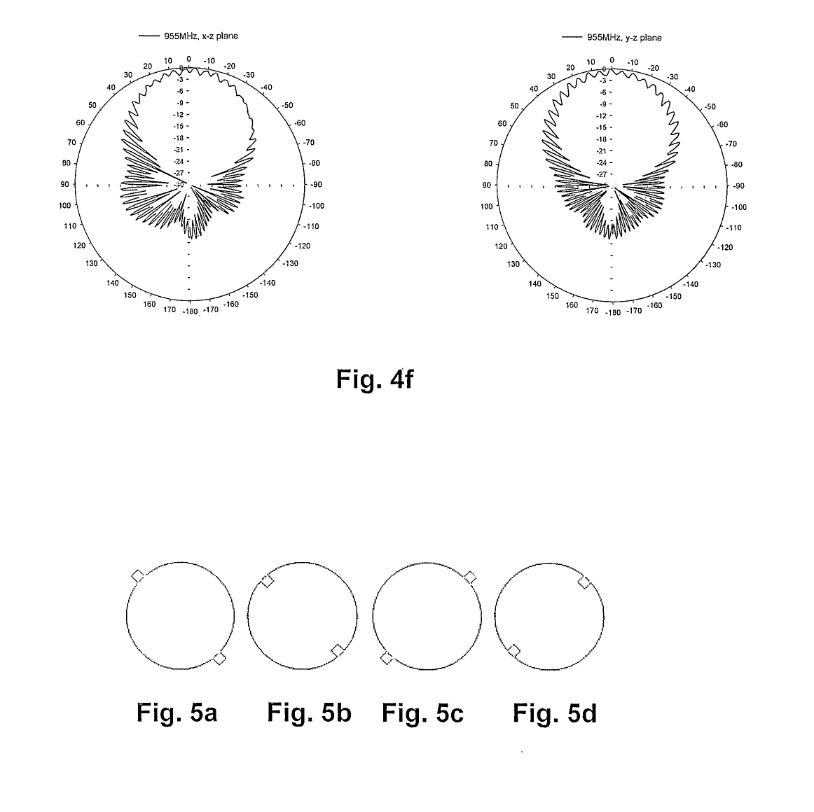

Furthermore, as described above, the first and second radiating patch layer 110c/110d is preferably a substantially primitive geometric shape such as a square or a rectangle. Other primitive geometric shapes such as a circle are also implementable, as shown in FIG. 5a to FIG. 5d.

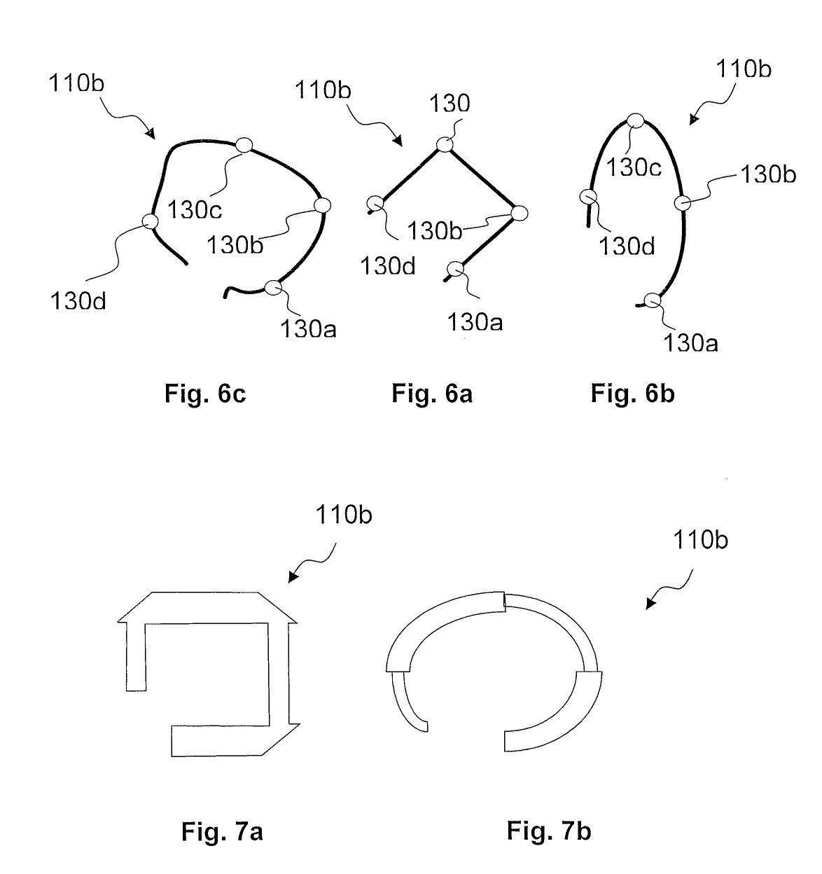

Similarly, apart from being shaped as described above, other shapes are also implementable for the feed line layer 110b. In one example, the feed line layer 110b is a primitive geometric shape with a portion removed from the primitive geometric shape. As shown in FIG. 6a and FIG. 6b, the feed line layer 110b is a square and oval shape. A portion is removed from each of the square and oval shape. In another example, the feed line layer 110b has an irregular shape as shown in FIG. 6c.

Additionally, it is not necessary for the width of the feed line layer 110b to be substantially uniform as described above. The width of the feed line layer 110b can also be non-uniform as shown in FIG. 7a and FIG. 7b.

1. An antenna structure comprising:
a feed line layer shaped and dimensioned as an open loop having an input portion, signals being feedable to the feed line layer via the input portion;
a first radiating patch layer stacked adjacent to the feed line layer, the first radiating patch layer having a reference origin defined thereon; and
a plurality of probes disposed between the feed line layer and the first radiating patch layer for coupling therebetween, the signals being feedable to the first radiating patch layer via the plurality of probes, each of the plurality of probes being positioned about the reference origin of the radiating patch layer along the length of the feed line layer,
wherein the signals achieve a phase difference for providing circularly polarized radiation in response to being fed via the plurality of probes being positioned about the reference origin of the radiating patch layer along the length of the feed line layer.

2. The antenna structure as in claim 1 further comprising a second radiating patch layer stacked adjacent to the first radiating patch layer for improvement of axial ratio bandwidth.

3. The antenna structure as in claim 2 further comprising a plurality of stack patches arranged adjacent to the first radiating patch layer for further improvement of the axial ratio bandwidth.

4. The antenna structure as in claim 2 further comprising a ground plane and a connector, the connector connectable to the input portion with the ground plane layer disposed therebetween, the feed line layer separable from the ground plane layer by a first substrate.

5. The antenna structure as in claim 4, the feed line layer separable from the ground plane layer by a first substrate, the first radiating patch layer separable from the feed line layer by a second substrate and the first and second radiating patch layer separable by a third substrate.

6. The antenna structure as in claim 5, each of the first, second and third substrate formed from an insulating medium, the insulating medium being at least one of plastic, non-metallic spacers, wood, foam and air.

7. The antenna structure as in claim 5, each of the feed line layer, the ground plane, the first radiating patch layer and the second radiating patch layer being formed from conductive materials such as copper, brass or conductive ink.

8. The antenna structure as in claim 5, operating frequency of the antenna structure is determinable by thickness of each of the first substrate, second substrate and third substrate.

9. The antenna structure as in claim 5, operating frequency of the antenna structure is determinable by at least one of size of the first and second radiating patch layers, and dielectric parameters of each of the first substrate, second substrate and third substrate.

10. The antenna structure as in claim 4 dimensioned and configured for operating in ultra high frequency (UHF) band for radio frequency identification (RFID) applications.

11. The antenna structure as in claim 10 the antenna structure capable of operating at a frequency range of 815 MHz to 970 MHz with a gain of more than 8 dBic and an axial ratio of less than 3 dB.

12. The antenna structure as in claim 11, each of the of the feed line layer, the ground plane, the first radiating patch layer and the second radiating patch layer being a primitive geometric shape.

13. The antenna structure as in claim 12, the geometric shape being a square, each of the of the feed line layer, the ground plane, the first radiating patch layer and the second radiating patch layer having a length dimension of 121 mm, 250 mm, 156 mm and 139 mm respectively.

14. The antenna structure as in claim 13, each of the first, second and third dielectric having thicknesses of 5 mm, 19 mm and 10 mm respectively

15. The antenna structure as in claim 13, each of the feed line layer, the ground plane, the first radiating patch layer and the second radiating patch layer having at least having two adjacent corners removed.

16. The antenna structure as in claim 15, the feed line layer being shaped and dimensioned to have a substantially uniform width of 24 mm.

17. The antenna structure as in claim 1, the plurality of probes comprising:
a first probe;
a second probe, the signals fed from the second probe having a substantially ninety degree phase delay relative the signals fed from the first probe;
a third probe, the signals fed from the third probe having a substantially ninety degree phase delay relative to the signals fed from the second probe; and
a fourth probe, the signals fed from the fourth probe having a substantially ninety degree phase delay relative to the signals fed from the third probe.

18. An antenna structure comprising:
a connector;
a ground plane layer;
a feed line layer shaped as an open loop having an input portion, the connector connectable to the input portion with the ground plane layer disposed therebetween, the feed line layer separable from the ground plane layer by a first substrate, signals being feedable to the feed line layer via the input portion;
a first radiating patch layer stacked adjacent to the feed line layer, the first radiating patch layer having a reference origin defined thereon and the first radiating patch layer separable from the feed line layer by a second substrate;
a plurality of probes disposed between the feed line layer and the first radiating patch layer, the plurality of probes coupling the feed line layer and the first radiating patch layer, the signals being feedable from the feed line layer to the first radiating patch layer via the plurality of probes, each of the plurality of probes being positionable about the reference origin of the first radiating patch layer along the length of the feed line layer; and
a second radiating patch layer stacked adjacent to the first radiating patch layer for improvement of axial ratio bandwidth, the first and second radiating patch layers separable by a third substrate,
wherein the signals achieve a substantially ninety degree phase difference for providing circularly polarized radiation in response to being fed via the plurality of probes being positioned about the reference origin of the radiating patch layer along the length of the feed line layer and operating frequency of the antenna structure is determinable by thickness of each of the first substrate, second substrate and third substrate.

19. The antenna structure as in claim 18 further comprising a plurality of stack patches arranged adjacent to the first radiating patch layer for further improvement of the axial ratio bandwidth.

20. The antenna structure as in claim 18 dimensioned and configured for operating in ultra high frequency (UHF) band for radio frequency identification (RFID) applications.

21. The antenna structure as in claim 18 the antenna structure capable of operating at a frequency range of 815 MHz to 970 MHz with a gain of more than 8 dBic and an axial ratio of less than 3 dB.

22. The antenna structure as in claim 18, operating frequency of the antenna structure is determinable by at least one of size of the first and second radiating patch layers, and dielectric parameters of each of the first substrate, second substrate and third substrate.
